(19) United States
(12) Patent Application Publication
(10) Pub. No.: US 2023/0367618 A1
(43) Pub. Date: Nov. 16, 2023

(54) METHOD FOR TRACKING USER INTERACTIONS WITH WEB PAGES

(71) Applicant: JENTIS GMBH, Wien (AT)

(72) Inventors: Thomas Tauchner, Eckartsau (AT); Walter Parigger; Christian Kletzander, Hohenau/March (AT)

(21) Appl. No.: 18/245,021

(22) PCT Filed: Sep. 8, 2021
(86) PCT No.: PCT/AT2021/060319

§ 371 Date: Mar. 13, 2023

(30) Foreign Application Priority Data
Sep. 11, 2020 (AT) A60281/2020

(51) Int. Cl. G06F 9/455; G06F 16/957; H04L 67/1396

(52) U.S. Cl. CPC G06F 9/455; G06F 16/957; H04L 67/1396

(57) ABSTRACT

A method and an arrangement for acquiring and distributing user interactions in a web browser include transmitting contents of a web page from a web server to a client. The web page content includes a synchronization script for setting up a connection between the client and an emulation system, in particular running on a further server. The synchronization script is executed by the client, resulting in a connection between the client and the emulation system. Transmission of acquisition data acquired by the client through the connection results in user interactions and subsequent responses of the web page content being emulated in the client by the emulation system and being available. The emulation system is configured such that the presence of specific user interactions or responses of the transmitted web page content results in messages in this regard being sent to one or more further servers.

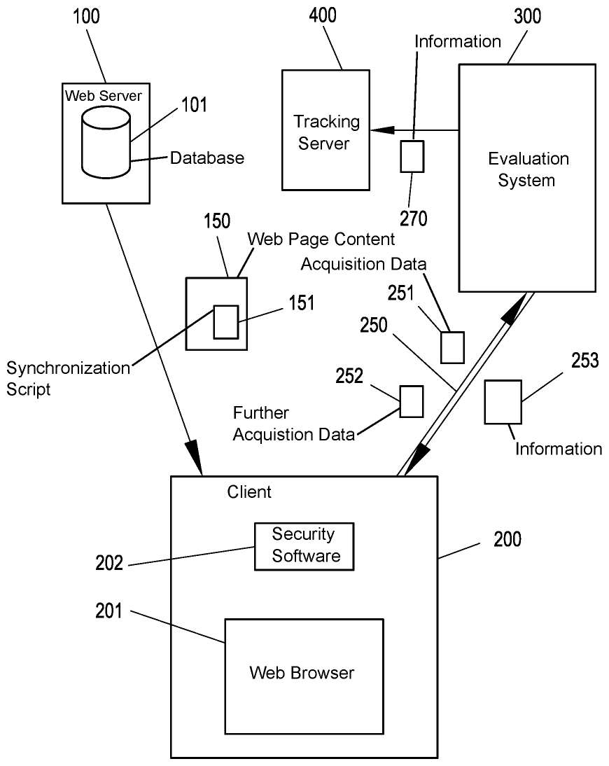

The invention relates to a method for acquiring and distributing user interactions in a web browser. The invention additionally relates to an arrangement for acquiring and distributing user interactions.

Different variants and procedures are known from the prior art, with which it is possible to acquire processes that are running on a web client, to store them and optionally to keep them available for further use.

A frequent problem occurs if, intentionally or coincidentally, individual functions required in the web application are not available, are suppressed or are incorrectly executed on the part of the web client. In this case it is then not possible to acquire the user interactions in the web browser correctly and process them appropriately.

Problems can occur in individual cases precisely in relation to so-called ad-blockers or similar types of security software, which proactively suppress certain system calls. In many cases in which the users have granted their consent to data transmission, and are even actively interested in a data transmission, the use of ad-blockers has the effect that the data is not transmitted or only partially transmitted, so that the functioning of the web page being used is only possible to a limited extent if at all. In these cases, ad-blockers or similar tools thus constitute an obstacle, so that it is necessary to implement the user's already granted consent in a different manner.

The invention solves this problem in the method of the type mentioned in the introduction.

According to the invention, the following steps are provided in a method for acquiring and distributing user interactions in a web browser:
transmitting the content of a web page from a web server to a client, wherein the web page content comprises a synchronization script, which is designed to establish a connection between the client and an emulation system running in particular on a further server,
executing the synchronization script by means of the client, whereby a connection is established between the client and the emulation system,
transmitting, via the connection, acquisition data acquired by means of the client, such that user interactions and subsequent responses of the web page content in the client are emulated by the emulation system and are available, and
configuring the emulation system in such a way that, if specific user interactions or responses of the transmitted web page content are present, messages in relation thereto are sent to one or more further servers.

In order to be able to acquire and process additional inputs, it can be provided that the emulation system is configured in advance for the web page of the web server, such that the web server transmits an additional code portion in the synchronization script to the client, which code portion prompts the client to ascertain further acquisition data, and the emulation system processes the further acquisition data on the basis of the configuration and/or of the web page content transmitted by the client to the emulation system.

A more flexible procedure is made possible by configuring the emulation system in advance for the web page content of the web server such that, upon transmission of acquisition data, and optionally further acquisition data originating from the execution of the respective web page content, the emulation system prompts the execution of steps specified in advance in the configuration.

An adaptation to different representations on client computers can be effected easily in that the client transmits information relating to the arrangement and/or position of individual elements, in particular operating elements, in the display region of the client to the emulation system, and in that a user interaction is considered to have occurred if the acquisition data relates to image positions that are defined by the information.

According to the invention, it is provided in an arrangement that the web server is designed to transmit the content of one of the web page content of a web page to a client on request, wherein the web page content comprises a synchronization script, which is designed to establish a connection between the client and an emulation system running in particular on a further server, that the client has a user-operable web browser that is designed to execute the synchronization script and thereby to establish a connection between the client and the emulation system, and to acquire acquisition data specified in the synchronization script and transmit the data via the connection to the emulation system, that the emulation system is designed to emulate user interactions and subsequent responses of the web page content in the client by means of the emulation system, and that the emulation system is configured in such a way that, if certain user interactions or responses of the transmitted web page content are present, messages in relation thereto are sent to one or more further servers.

In order to be able to acquire and process additional inputs, it can be provided that the emulation system is configured in advance for the web page content of the web server, such that the web server transmits an additional code portion in the synchronization script to the client, which code portion prompts the client to ascertain further acquisition data, and such that the emulation system is designed to process the further acquisition data on the basis of the configuration and/or of the web page content transmitted by the client to the emulation system.

A more flexible operation of the arrangement is made possible by configuring the emulation system in advance for the web page content of the web page of the web server such that, upon transmission of acquisition data, and optionally further acquisition data originating from the execution of the respective web page content, the emulation system prompts the execution of steps specified in advance in the configuration.

The FIGURE shows an arrangement according to a first embodiment of the invention in detail. This arrangement comprises a web server 100, on which a web page is made available. The applications or the web page made available by the web server 100 can involve an arbitrarily complicated application.

In particular, any desired server-side and client-side automation processes can be connected in relation with the invention. For example, a database 101 can be provided on the server, the contents of which are used in the creation of individual web page contents 150 transmitted by the web server 100 to a client 200.

The client 200 is connected to the web server 100. A web browser 201 installed on the client has the capability to locally run scripts, typically written in the JavaScript programming language, which were transmitted to the web browser from the web server 100.

In the present exemplary embodiment, the client 200 or the web browser 201 transmits a page request to the web server 100. The web server 100 then transmits the content of the page or the web page content 150 to the client 200, and the web server 100 also transmits a synchronization script 151 in the web page content 150 to the client 200. This synchronization script 151 is typically started automatically when the web page content 150 is displayed in the web browser 201 of the client 200. Alternatively, however, there is also the possibility of starting the synchronization script 151 only if the user confirms the start-up or if the user actively opens the synchronization script 151.

The synchronization script 151 is active during the display and usage of the web page or the web page content 150 on the client 200 or in the web browser 201, and simultaneously performs two different functions:

Firstly, the synchronization script 151 establishes a permanent communication 250 with an emulation system 300. The logic contained in the synchronization script 151 has the purpose of allowing individual items of or all of the state information for the web page in question to be available both in the client 200 and on the emulation system 300. This emulation system 300 is typically situated on a further server that is independent of the web server 100 and has a data communication connection thereto. The emulation system 300 is defined in the synchronization script 151 such that the client 200 or the web browser 201 establishes such a communication 250 immediately after the displaying of the web page content 150 begins. The synchronization script 151 preferably continues to run during the entire display duration of the web page content 150 and is not terminated until the web page content 150 is no longer displayed on the web browser 201.

Secondly, the synchronization script 151 running on the client 200 determines, during display of the web page content 150, those user actions, responses and optionally further events which are necessary for the further analysis of the user behavior and have been defined accordingly in the synchronization script 151. There is thus the possibility, for example, of acquiring the following acquisition data 251 during the display of a web page:
course of the mouse pointer
touches of the touch screen and mouse clicks
actuation of buttons
the fact that the mouse pointer is located above a button
events that result as consequences of user interactions and optionally of further data
keyboard inputs
date and time
information on the web browser used
information on the client system
length and width of the browser window

All the acquisition data 251 is transmitted by the client 200 via the connection 250 to the emulation system 300, in order to be able to replicate the state of the client 200 in the emulation system 300. An emulation of the web page, as also displayed with the web browser 201 in the client 200, is running in this emulation system 300. To start the emulation, it can be provided, for example, that immediately when the connection 250 begins to be established, the emulation system opens a web page in order to be able to emulate the web page content 150. The task of the emulation system 300 is to replicate all user interactions and program responses of the user on the client 200 or the web browser 201 and to replicate the programming of the web page in the way that it actually takes place on the web browser 201. On the basis of the acquisition data 251 relating to the web browser 201 and the browser window being used, it is possible for the emulation system 300 to ascertain mouse movements and actuations as well as the positions thereof and to assign these positions and these individual buttons to the web page, as also takes place in the web browser 201 on the client 200.

The synchronization script 151 also has the effect that individual items of information 253 as to how the web page is concretely displayed and/or constructed or functions on the client 200 are likewise transmitted to the emulation system 300. Such information 253 can relate, for example, to the concrete position of individual operating elements on the display screen of the client 200.

In this manner, it is possible to tell immediately in the emulation system 300, too, that the user of a web page clicks on a button.

Precisely when the individual positions of operating elements change due to the different size of the display available on the client, the actuation of an operating element can be detected if the client 200 transmits information 253 relating to the arrangement and/or position of individual elements in its display region to the emulation system. By way of example, the coordinate boundaries of a rectangular operating field, for instance, can be transmitted as such information 253. A user interaction is considered to have occurred if the acquisition data 251, for example the position of the mouse pointer or the pressing position on a touchscreen, relates to image positions that are defined by the information 253, e.g. are situated within the rectangular image region of the operating field as defined by the information.

If security software 202 running locally on the client 200 prevents, on the client 200, a script assigned to the button from being executed on the client 200, this does not inhibit the present arrangement. Software corresponding to the security software 202 is not actually installed on the emulation system 300 and therefore the respective script is executed on the emulation system 300. It is thus possible for the script assigned to the button to be executed on the emulation system 300 even if security software 202 would prevent execution of the script on the client 200.

For example, if the purpose of the script is to transmit information 270 to a tracking server 400 when the button is actuated, the transmission of which the client-side software or the security software 202 wishes to prevent, this data transmission can be performed from the further server.

It is not necessary in principle to coordinate the web server and the emulation system 300 in advance. If a synchronization script 151 provided for the emulation system 300 is used, the emulation system 300 can in principle emulate the usage of the web page or the web page content 150 by the client 200 on the web browser 201. In a preferred embodiment of the invention, a further configuration of the web server 100 with the emulation system 300 can be undertaken prior to the performance of the emulation.

A first configuration relates to the acquisition data 251. Many applications use, in addition to the typical inputs used on web pages, additional inputs such as audio or camera data, sensors or the like. This data is not considered part of the typical acquisition data 251 and is accordingly not acquired by default.

In the second exemplary embodiment of the invention, a web page that requires this additional data is used. Therefore, a configuration is undertaken in advance, in which the emulation system 300 is informed that, in addition to the typical acquisition data 251, for the web page content 150 of this web page, special acquisition data 252, specifically audio and acceleration, is also transmitted.

In this case, the emulation system 300 has an additional emulated audio input and an additional emulated sensor input fed by the further acquisition data 252 that is transmitted from the client 200.

The client 200 in turn receives a modified synchronization script 151 that prompts the client 200 to transmit the audio signal it has recorded as well as the acceleration information.

1-7. (canceled)

8. A method for acquiring and distributing user interactions in a web browser, the method comprising steps of:
transmitting a content of a web page from a web server to a client, the web page content including a synchronization script configured to establish a connection between the client and an emulation system;
executing the synchronization script by using the client and establishing the connection between the client and the emulation system;
transmitting, over the connection, acquisition data acquired by using the client, causing user interactions and subsequent responses of the web page content in the client to be emulated by the emulation system and to be available; and
configuring the emulation system to ensure that upon specific user interactions or responses of the transmitted web page content being present, messages in relation thereto are sent to one or more further servers.

9. The method according to claim 8, which further comprises executing the emulation system on a further server.

10. The method according to claim 8, which further comprises configuring the emulation system in advance for the web page of the web server, causing:
the web server to transmit an additional code portion in the synchronization script to the client, the additional code portion prompting the client to ascertain further acquisition data; and
the emulation system to process the further acquisition data based on at least one of a configuration or the web page content transmitted by the client to the emulation system.

11. The method according to claim 8, which further comprises configuring the emulation system in advance for the web page content of the web server such that, upon transmission of acquisition data, and optionally further acquisition data originating from an execution of a respective web page content, the emulation system prompts an execution of steps specified in advance in the configuration.

12. The method according to claim 8, which further comprises:
using the client to transmit information relating to at least one of an arrangement or a position of individual elements or operating elements in a display region of the client to the emulation system; and
considering a user interaction to have occurred when the acquisition data relates to image positions defined by the information.

13. An arrangement for acquiring and distributing user interactions, the arrangement comprising:
a web server, a client and an emulation system;
said web server configured to transmit a content of a web page to a client on request, the web page content including a synchronization script configured to establish a connection between said client and said emulation system;
said client having a user-operable web browser configured to execute said synchronization script and to thereby:
establish said connection between said client and said emulation system, and
acquire acquisition data specified in said synchronization script and transmit the acquisition data over said connection to said emulation system;
said emulation system configured to emulate user interactions and subsequent responses of the web page content in said client by using said emulation system; and
said emulation system configured, upon specific user interactions or responses of the transmitted web page content being present, to cause messages in relation thereto to be transmitted to one or more further servers.

14. The arrangement according to claim 13, wherein said emulation system runs on a further server.

15. The arrangement according to claim 13, wherein said emulation system is configured in advance for the web page content of said web server, to cause:
said web server to transmit an additional code portion in said synchronization script to said client, the additional code portion prompting said client to ascertain further acquisition data; and
said emulation system to process the further acquisition data based on at least one of a configuration or the web page content transmitted by said client to said emulation system.

16. The arrangement according to claim 13, wherein:
said emulation system is configured in advance for the web page content of the web page of said web server; and
upon transmission of acquisition data or further acquisition data originating from an execution of a respective web page content, said emulation system prompting an execution of steps specified in advance in a configuration.
